(19) United States
(12) Patent Application Publication
(10) Pub. No.: US 2026/0214431 A1
(43) Pub. Date: Jul. 23, 2026

(54) Mitigation for Connection Errors and Wireless Device Discovery

(71) Applicant: Apple Inc., Cupertino, CA (US)

(72) Inventors: Paul B. FRUHAUF, Santa Clara, CA (US); Yann LY-GAGNON, San Francisco, CA (US); Zachary A. ROSEN, Emerald Hills, CA (US)

(21) Appl. No.: 19/035,054

(22) Filed: Jan. 23, 2025

(51) Int. Cl. H04W 8/00; H04W 52/02; H04W 76/10

(52) U.S. Cl. CPC H04W 8/005; H04W 52/0209; H04W 76/10

(57) ABSTRACT

An apparatus configured to scan for wireless devices using a first Received Signal Strength Indicator (RSSI) threshold for triggering a discovery of a wireless device, upon a determination that one or more erroneous scans have occurred, dynamically reduce a scan sensitivity of the apparatus by decreasing the first RSSI threshold to a second RSSI threshold for triggering the discovery of the wireless device, wherein the second RSSI threshold is to be used in additional scans and progressively continue to reduce the scan sensitivity of the apparatus by continuing to decrease a RSSI threshold for triggering the discovery of the wireless device for subsequent scans until a non-erroneous scan occurs.

### BACKGROUND

A user equipment (UE) may establish a short-range connection (e.g., Bluetooth, Bluetooth Low Energy (BLE), etc.) to another device. In accordance with a variety of different power saving mechanisms, the UE may not maintain the short-range connection to the other device when the application processor of the UE is asleep, e.g., to avoid the power consumption associated with waking up the application processor. However, this may prevent the other device from performing certain types of tasks for the UE.

In addition, wireless devices, like Bluetooth capable phones, often scan their environment to discover other wireless devices before initiating a connection. The connection may fail for a variety of reasons which may result in the initiating device re-discovering the secondary device during the next scan and attempting to connect again. This may result in an endless loop of connection attempts if the underlying issue is not resolved or if mitigations are not implemented. On an embedded system (e.g., a phone or watch) this causes significant battery drainage as the device is always trying to reconnect. A typical mitigation is to temporarily “ban” devices that are failing to connect. However, in some scenarios (e.g., unpaired BT devices) keeping a “ban” list may not be possible. Accordingly, there is a need for mitigation for connection errors and wireless device discovery, and a need for mechanisms configured to maintain a short-range connection between the UE and another device in a power efficient manner.

### SUMMARY

Some example embodiments are related to an apparatus having processing circuitry configured to scan for wireless devices using a first Received Signal Strength Indicator (RSSI) threshold for triggering a discovery of a wireless device, upon a determination that one or more erroneous scans have occurred, dynamically reduce a scan sensitivity of the apparatus by decreasing the first RSSI threshold to a second RSSI threshold for triggering the discovery of the wireless device, wherein the second RSSI threshold is to be used in additional scans and progressively continue to reduce the scan sensitivity of the apparatus by continuing to decrease a RSSI threshold for triggering the discovery of the wireless device for subsequent scans until a non-erroneous scan occurs.

Other example embodiments are related to a method for scanning for wireless devices using a first Received Signal Strength Indicator (RSSI) threshold for triggering a discovery of a wireless device, upon a determination that one or more erroneous scans have occurred, dynamically reducing a scan sensitivity of the apparatus by decreasing the first RSSI threshold to a second RSSI threshold for triggering the discovery of the wireless device, wherein the second RSSI threshold is to be used in additional scans and progressively continuing to reduce the scan sensitivity of the apparatus by continuing to decrease a RSSI threshold for triggering the discovery of the wireless device for subsequent scans until a non-erroneous scan occurs.

Still further example embodiments are related to an apparatus wirelessly linked to a companion device, wherein the companion device is in a power-saving mode in which scanning for wireless devices has been disabled, the apparatus having processing circuitry configured to scan for wireless devices using a Received Signal Strength Indicator (RSSI) threshold, and upon successfully detecting a wireless device, transmitting a notification to the companion device to re-enable scanning for the wireless device by the companion device.

### BRIEF DESCRIPTION OF THE DRAWINGS

FIG. 1 shows an example arrangement according to various example embodiments.

FIG. 2 shows an example user equipment (UE) according to various example embodiments.

FIG. 3 shows a diagram illustrating how a scan sensitivity of an example wireless device is reduced dynamically until a non-erroneous scan is reached according to various example embodiments.

FIG. 4 shows a diagram illustrating how an example wireless device is reset to use a typical Bluetooth Received Signal Strength Indicator (BT RSSI) signal strength when certain conditions are met according to various example embodiments.

FIG. 5 shows a diagram illustrating how an example wireless device is reset to use a typical BT RSSI signal strength when certain conditions are met for a companion wireless device according to various example embodiments.

FIG. 6 shows a diagram illustrating how an example smart watch notifies an example BT-enabled cellular telephone that is in a power-saving mode to re-enable scanning for a third device according to various example embodiments.

### DETAILED DESCRIPTION

The example embodiments may be further understood with reference to the following description and the related appended drawings, wherein like elements are provided with the same reference numerals. The example embodiments relate to maintaining a short-range connection between two devices in a power efficient manner and, in particular, to providing mitigation for connection errors and wireless device discovery.

The example embodiments are described with regard to a user equipment (UE). However, reference to a UE is merely provided for illustrative purposes. The example embodiments may be utilized with any electronic component that is equipped with the hardware, software, and/or firmware to wirelessly exchange signals with a network and/or another separate device. Therefore, the UE as described herein is used to represent any electronic component.

The example embodiments are also described with reference to maintaining a Bluetooth connection between two UEs. Those skilled in the art will understand that Bluetooth (e.g., Bluetooth, Bluetooth Low-Energy (BLE), etc.) is a specific type of communication protocol that enables short-range communication between two or more devices. While the example embodiments provide benefits to Bluetooth, the example embodiments are not limited to Bluetooth and may be implemented using any appropriate type of wireless communication protocol. Therefore, any reference to terms such as, “Bluetooth,” “BLE,” “short-range communication protocol,” “short-range connection,” or “short-range communication link” are provided for illustrative purposes and not intended to limit the example embodiments to any particular type of wireless communication protocol.

A UE may experience a power drain when it wakes up its

application processor from a sleep mode or other lower-power state. When a first UE is connected to second UE via Bluetooth, the second UE may send messages to the first UE that trigger the first UE to wake up its application processor. Thus, in accordance with various power saving mechanisms, a UE may not allow another device to remain connected via Bluetooth when the UE's application processor is asleep (e.g., in a lower-power state than an operating state). In addition, wireless devices, like Bluetooth capable phones, often scan their environment to discover other wireless devices before initiating a connection. This is particularly true of passive wireless devices that are always on (e.g., passive entry through a door lock using a cellular phone), as well as for unpaired BT devices. The connection may fail for a variety of reasons which will result in the initiating device re-discovering the secondary device during the next scan and attempting to connect again. This may result in an endless loop of connection attempts if the underlying issue is not resolved or if mitigations are not implemented. On an embedded system (e.g., a phone or watch) this causes significant battery drainage as the device is always trying to reconnect. A typical mitigation is to temporarily “ban” devices that are failing to connect.

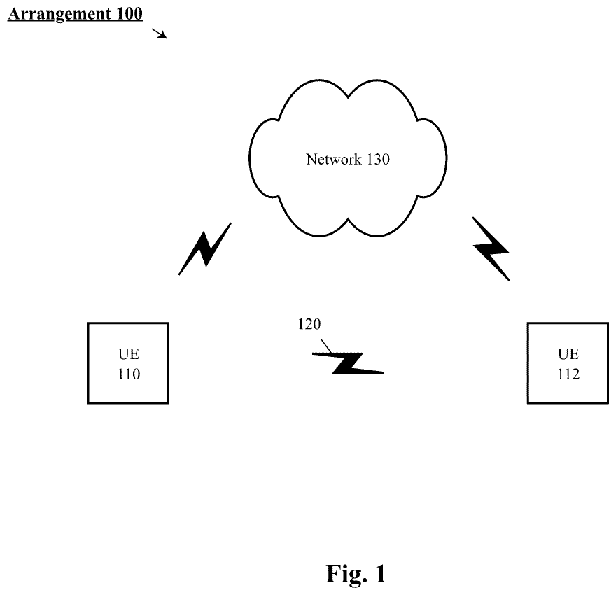

As will be described in more detail below with regard to the arrangement 100 of FIG. 1, it has been identified that these types of power saving mechanisms may prevent the implementation of certain types of functionalities. Further, in some scenarios (e.g., unpaired BT devices), keeping a “ban” list may not be possible. The example embodiments introduce alternative mechanisms that enable the UE to maintain a short-range connection to another device in a power efficient manner by providing mitigation for connection errors and wireless device discovery.

FIG. 1 shows an example arrangement 100 according to

various example embodiments. The arrangement 100 includes a UE 110, a UE 112 and a network 130. The network 130 may be a fifth generation (5G) new radio (NR) network, a long term evolution (LTE) network, a legacy cellular network, an evolution of the cellular network (e.g., 6G, 7G, etc.), a wireless local area network (WLAN), a mesh network, or any other appropriate type of network.

The UEs 110, 112 and a remote device (not shown) may access the network 130 via an access node (e.g., base station, access point, router, etc.). Any appropriate type of association procedure may be performed for the UEs 110, 112 to connect to the network 130 via the access node. However, the manner in which the UEs 110, 112 may connect to the network 130 is beyond the scope of the example embodiments nor do the example embodiments require either the UE 110 or the UE 112 to be connected to the network 130.

To provide a non-limiting example within the context of the example arrangement 100, the UE 110 may be a smart watch and the UE 112 may represent a wearable sensor (e.g., a glucose monitor, an electrocardiogram (EKG) sensor, a biosensor, etc.). However, as indicated above, the example embodiments are not limited to these types of devices and the UEs 110, 112 each may represent any type of electronic component that is configured for wireless communication (e.g., mobile phones, tablet computers, desktop computers, smartphones, phablets, embedded devices, wearables, Internet of Things (IoT) devices, sensors, etc.).

The UEs 110, 112 may communicate with one another using a short-range communication protocol (e.g., Bluetooth, BLE, etc.). Accordingly, when the UE 110 and the UE 112 are within proximity of one another (e.g., within a distance in which BLE communications may be performed), the UE 110 and the UE 112 may exchange data over the communication link 120. In some implementations, the UE 110 and the UE 112 may have a companion relationship where the UE 110 is a source device, and the UE 112 is an accessory device. Thus, in some examples, the UE 110 may connect to a network 130 and relay data exchanged with the network 130 to the UE 112 over the short-range communication link 120.

In one example, the UE 110 may be a smart watch, and the UE 112 may be a wearable sensor (e.g., glucose monitor, EKG, biosensor, etc.). The UE 112 may be a third party device that is configured to collect data from a user and provide the data to the UE 110 via the short-range communication link 120. However, the UE 110 may be configured to not maintain a connection to third party devices when the application processor of the UE 110 is asleep. While this mechanism may provide power saving benefits to the UE 110, it has been identified that this mechanism may prevent the UE 112 from being able to reliably trigger alarms by sending a signal to the UE 110. For example, a glucose monitor may be unable to notify the UE 110 about a low sugar detection event when the application processor of the UE 110 is asleep.

In other situations, the UE 110 and/or the UE 112 may scan their environment to discover other wireless devices before initiating a connection. This is particularly true of passive wireless devices that are always on (e.g., passive entry through a door lock using a cellular phone), as well as for unpaired BT devices. For example, a group of devices may be capable of implementing a particular BT service, but that BT service may be causing a power drain on one or more of the group of devices due to one or more of the group of devices continually trying to connect to another device for that BT service and the connection failing. The connection may fail for a variety of reasons which may result in the initiating device re-discovering the secondary device during the next scan and attempting to connect again. This may result in an endless loop of connection attempts if the underlying issue is not resolved or if mitigations are not implemented. On an embedded system (e.g., a phone or watch) this causes significant battery drainage as the device is always trying to reconnect. The example mechanisms introduced herein utilize a different approach which provides mitigation for these connection errors and wireless device discovery.

As mentioned above, the example embodiments may support the implementation of certain types of functionalities between devices, such as a smart watch and a wearable sensor. However, the example embodiments introduced herein are not limited to maintaining a connection between these two types of devices. The example embodiments introduced herein may be used by any appropriate type of device configured to establish a short-range connection to one or more other devices.

According to some aspects, the example embodiments may implement progressive reduction of the BT Received Signal Strength Indicator (RSSI) that triggers the discovery and wakes up the embedded device. That is, once a device that is causing an erroneous connection and potentially draining power is identified, the signal strength that is triggering that discovery and erroneous connection may be progressively reduced. By reducing the signal strength needed to trigger the discovery, further erroneous readers may be progressively eliminated until a stable power state is reached. Any scan that triggers a discovery of a device where the attempted connection fails for any reason which will result in the initiating device re-discovering the secondary device during the next scan and attempting to connect again may be referred to as an erroneous scan; otherwise, the scan may be referred to as non-erroneous scan. The above example is merely provided for illustrative purposes and is not intended to limit the example embodiments in any way.

The example mechanisms introduced herein may be used independently from one another, in conjunction with other currently implemented mechanisms related to providing mitigation for connection errors and wireless device discovery, with future implementations of mechanisms related to providing mitigation for connection errors and wireless device discovery, or independently from other mechanisms related to providing mitigation for connection errors and wireless device discovery.

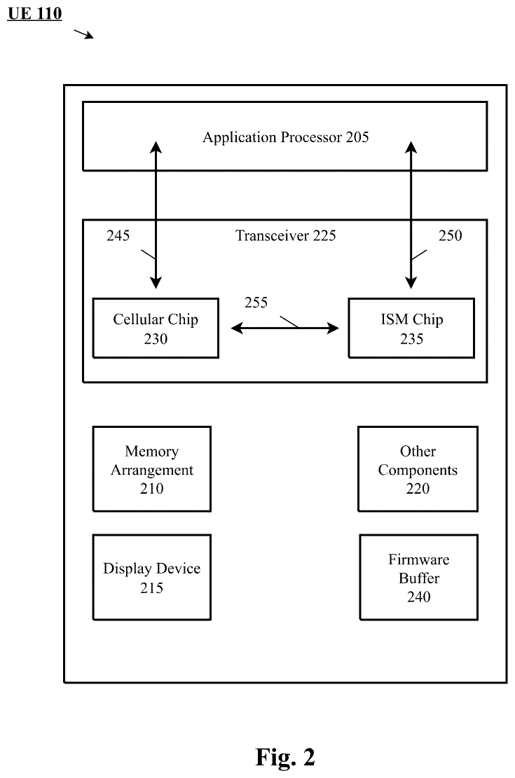

FIG. 2 shows an example UE 110 according to various example embodiments. The UE 110 may represent the UEs 110, 112 from the arrangement 100 of FIG. 1 or any other type of device configured to communicate directly with another device using a short-range communication protocol. The UE 110 may include an application processor 205, a transceiver 225, a cellular chip 230, an industrial scientific and medical (ISM) chip 235, a memory arrangement 210, a display device 215, a firmware buffer 240 and other components 220. The other components 220 may include, for example, an input/output (I/O) device, an audio input device, an audio output device, a power supply, a data acquisition device, ports to electrically connect the UE 110 to other electronic devices, sensors to collect data from a user, etc.

The application processor 205 may be configured to execute a plurality of applications for the UE 112. For example, the applications may include, but are not limited to, a web browser, a health monitoring application, and a voice call application. The example embodiments are described with regard to the application processor 205 utilizing a sleep mode to conserve power. Throughout this description, any reference to a power saving mode, a sleep mode, or other such period of inactivity being used by the application processor 205 does not necessarily mean putting all of the components of the UE 110 to sleep, in hibernation, or in a deactivated state. For example, the UE 110 may still exchange signals with another device (e.g., UE 112) over a short-range communication link and/or a network. Instead, the power saving mode described herein relates to conserving power by discontinuing at least a subset of processing functionality associated with the application processor.

The memory arrangement 210 may be a hardware component configured to store data related to operations performed by the UE 110. The display device 215 may be a hardware component configured to show data to a user. The display device 215 and an I/O device may be separate components or integrated together such as a touchscreen.

The transceiver 225 may be a hardware component configured to wirelessly transmit and/or receive data. Thus, the transceiver 225 may enable communication with other electronic devices directly or indirectly through a network. The transceiver 225 may operate on a variety of different frequencies or channels (e.g., set of consecutive frequencies) that are related to a cellular network and/or a WLAN network. The transceiver 225 may also perform wireless functionalities for short range communications such as Bluetooth, BLE, etc. Accordingly, the transceiver 225 may work in conjunction with a cellular chip 230 for the wireless functionalities related to cellular networks and an ISM chip 235 for the wireless functionalities for short-range communications such as Bluetooth, BLE, etc.

The components of the UE 112 may be disposed at least partially on an integrated circuit board (ICB). Accordingly, the cellular chip 230, the ISM chip 235, and the application processor 205 may be disposed on the ICB in which pathways may also exist between these components. For example, an interface 245 may be disposed to connect the cellular chip 230 to the applications processor 205 while interface 250 may be disposed to connect the ISM chip 235 to the applications processor 205. In addition, a coexistence interface 255 may be disposed to connect the cellular chip 230 to the ISM chip 235. The manner in which the cellular chip 230, the ISM chip 235, and the application processor 205 may be disposed on the ICB as well as the manner in which the interfaces or pathways 145, 150, 155 may be provided for the interconnections are only examples. The example embodiments may be implemented in any of these or other configurations of a UE.

In addition, the UE 110 may include the firmware buffer 240. The firmware buffer 240 may perform various operations related to buffering certain types of signals that may be exchanged over a short-range communication link. The firmware buffer 240 may enable the UE 110 to maintain a short-range connection in a power-efficient manner. The firmware buffer 240 may be implemented as a separate incorporated component of the UE 110, may be a modular component coupled to the UE 110, e.g., an integrated circuit. For example, the integrated circuit may include input circuitry to receive signals and processing circuitry to process the signals and other information. However, in some embodiments, the operations performed by the firmware buffer 240 may instead be performed by an integrated circuit without firmware, a baseband processor, the application processor 205, any combination thereof or any other appropriate component. Thus, the example embodiments are not required to utilize a buffer implemented in firmware and may utilize a buffer implemented in any appropriate manner. In addition, reference to a single firmware buffer 240 is provided for illustrative purposes, the UE 110 may be equipped with any appropriate number of firmware buffers.

As indicated above, the example embodiments introduce mechanisms for providing mitigation for connection errors and wireless device discovery. According to some aspects, the mitigating mechanism is described with reference to the UE 110 or UE 112 and may implement progressive reduction of the BT RSSI that triggers the discovery and wakes up the embedded device. That is, once a device that is causing an erroneous connection with the UE 110 or UE 112 and potentially draining power is identified, the signal strength that is triggering that discovery and erroneous connection may be progressively reduced. By reducing the signal strength needed to trigger the discovery, further erroneous readers may be progressively eliminated until a stable power state is reached. Further, after the reduction in BT RSSI that triggers the discovery and wakes up the embedded device goes beyond a certain threshold, scanning may be completely disabled until a reset condition happens.

To prevent a user experience from being permanently affected, this behavior may reset under certain conditions. That is, for the UE not to be affected permanently in terms of being able to make connections, the UE may be able to recover and go back to a typical RSSI signal strength for connections with other devices under certain conditions. These conditions may include one or more of the following: after a given amount of time since the last RSSI signal reduction; after certain user behavior, such as opening a wallet, geofence entry, etc.; after a successful operation on the UE; after a UE reboot or bio-lockout exit; and/or after a companion device to the UE resets for any of the above reasons. These reset conditions may be done on a per domain service basis, like service UUID (Universally Unique Identifier) type or other criteria. For example, one domain could be automotive, another could be access, another could be hospitality, and so on. The triggers for resetting the adaptive scan sensitivity may be domain specific and vary for different domains in some embodiments.

The adaptive scan sensitivity disclosed herein may also be done on a per domain service basis, like service UUID (Universally Unique Identifier) type or other criteria. For example, one domain could be automotive, another could be access, another could be hospitality, and so on. The adaptive scan sensitivity can be domain specific and may vary for different domains in some embodiments.

In one example, the scan sensitivity of the UE may be dynamically reduced until non-erroneous scan wakes are reached. In some example embodiments, the scan sensitivity may start at −106 dBm and may be decreased by twelve decibels (12 dB) for each of three erroneous scans or disconnects for that particular BT service until −70 dBm is reached. This may be referred to as three bubbles or iterations. As mentioned earlier, the particular scan sensitivity levels and the amount of and number of reductions may be domain specific such that they may vary for different domains. In some example embodiments, the scan sensitivity may be decreased for each of three erroneous scans over a given time period. Below −70 dBm, if erroneous scans are still occurring, passive entry may be disabled for the UE. Alternatively, the UE may be completely disabled from discovering and connecting to other devices. In some example embodiments, a notification may be sent to the user associated with the UE (such as to a wallet of the user) upon disabling of the passive entry. The disabling of the scans may be reset in some embodiments when a global timer expiration is reached. In some example embodiments, the global timer may be twenty-four (24) hours, although the length of the global timer period may vary. The disabling of the scans may also be reset upon certain user behaviors such as opening a wallet, geofence re-entry, etc., or upon a successful transaction by the UE, or upon a rebooting or bio-lockout exit of the UE, or upon a companion device to the UE resetting due to any of the above conditions.

The specific decibel values mentioned above in the example embodiments are simply one example and the mechanisms introduced herein are not limited to those specific decibel values. The mechanisms disclosed herein are agnostic to rotating addresses for BT devices; that is, these mechanisms may save power while still maintaining connectivity regardless of whether the BT device has its address rotated.

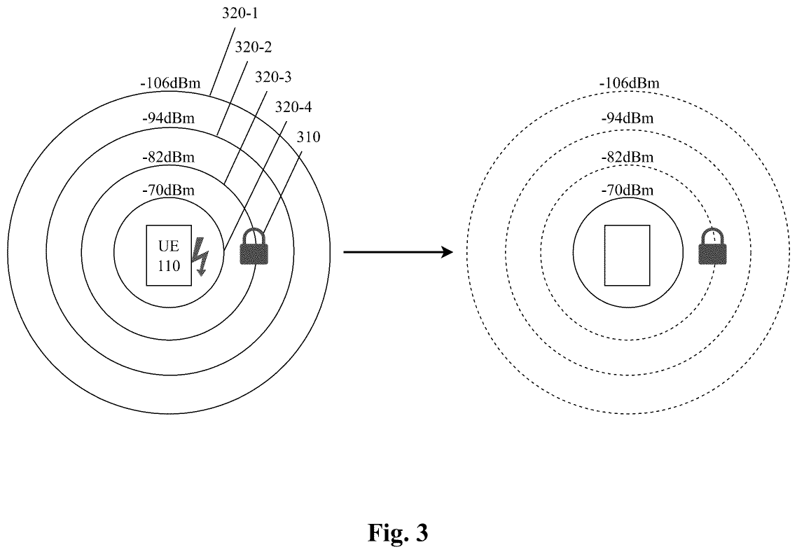

FIG. 3 shows a diagram illustrating how a scan sensitivity of an example wireless device is reduced dynamically until a non-erroneous scan wake is reached according to various example embodiments. In FIG. 3, a user may have a UE 110 such as a cellular telephone. The UE 110 may be an unpaired BT device in some example embodiments. There may be a lock 310 near the UE 110 that is unknown to the user. The UE may have a plurality of different BT bubbles 320 associated with the UE 110, each BT bubble 320 having a different BT bubble signal strength (different RSSI signal strengths for triggering device discovery and connections with other devices). For example, BT bubble 320-1 may have a BT bubble signal strength of −106 dBm, BT bubble 320-2 may have a BT bubble signal strength of −94 dBm, BT bubble 320-3 may have a BT signal strength of −82 dBm, and BT bubble 320-4 may have a BT bubble signal strength of −70 dBm. The lock 310 may be within one of the BT bubbles 320.

Because the lock 310 is near to the UE 110 (e.g., within one of the BT bubbles 320, the UE 110 may discover the lock 320 and may try to connect to it unsuccessfully. The unsuccessful connections may be continuous to the point that power draining of the UE 110 may occur. To avoid these unsuccessful connections from draining the battery of the UE 110, the BT bubbles may be reduced (e.g., the RSSI signal strength that triggers the device discovery and connection attempts, also known as scan sensitivity, is reduced) until non-erroneous wake scans are reached. Looking at FIG. 3, in this embodiment, the lock 310 is located on or inside BT bubble 320-3, so that once the RSSI signal strength is reduced to −70 dBm (BT bubble 320-4) (see the right side of the diagram), the lock 310 is outside BT bubble 320-4 and the UE 110 will no longer try to connect to the lock 310 unsuccessfully. At this point, the UE 110 would be in a power-saving mode as it would not be using power to try to unsuccessfully connect to the lock 310.

The mechanism described above of reducing the BT bubble may be performed dynamically to give the user associated with the UE 110 a best balance of connectivity with other devices but not continuously being in a state of unsuccessfully connecting to other devices. The described technique may apply regardless of distance between the UE 110 and other devices since it is based on the RSSI signal strength instead of distance, although there may be a relationship between distance and decibel strength. Again, the specific decibel values and BT bubbles mentioned above in FIG. 3 are simply one example and the mechanisms introduced herein are not limited to those specific decibel values or BT bubbles.

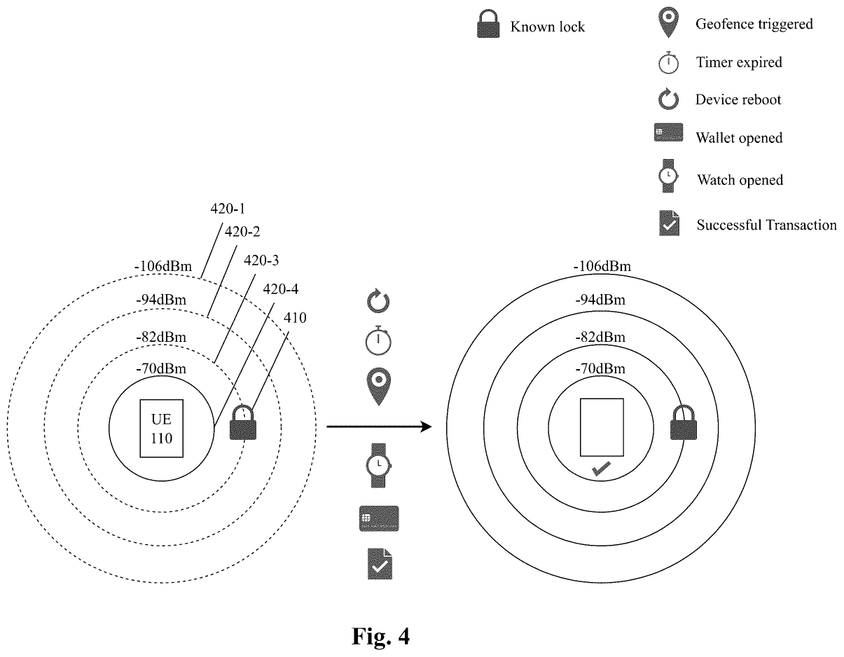

FIG. 4 shows a diagram illustrating how an example wireless device is reset to use a typical BT RSSI signal strength when certain conditions are met according to various example embodiments. In FIG. 4, a user may have a UE 110 such as a cellular telephone. There may be a lock 410 near the UE 110. The UE may have a plurality of different BT bubbles 420 associated with the UE 110, each BT bubble 420 having a different BT bubble signal strength (different RSSI signal strengths for triggering device discovery and connections with other devices). For example, BT bubble 420-1 may have a BT bubble signal strength of −106 dBm, BT bubble 420-2 may have a BT bubble signal strength of −94 dBm, BT bubble 420-3 may have a BT signal strength of −82 dBm, and BT bubble 420-3 may have a BT bubble signal strength of −70 dBm.

On the left side of FIG. 4, the scan sensitivity of an example wireless device may have been reduced due to a number of successful connection attempts, such as shown in FIG. 3. For example, as seen in FIG. 4, the RSSI signal strength that would trigger device discovery and connection attempts has been reduced to −70 dBm (BT bubble 420-4). At this point, the lock 410 may be outside the functional BT bubbles 420-4. The UE 110 at this point may have been locked out totally from communicating with other devices or at least locked out from any reasonable connection to other devices.

To not affect user experience for the UE 110 permanently, it is desirable to be able to reset the UE 110 to normal connection status under certain conditions. For example, for the UE 110 not to be affected permanently in terms of being able to make connections, the UE 110 may be able to recover and go back to a typical RSSI signal strength for connections with other devices under certain conditions. As seen in the right side of FIG. 4, upon a condition trigger being met, the UE 110 may be reset to using a typical RSSI signal strength to discover and connect to other devices. The following conditions are a non-exclusive list of conditions that triggers a reset: after a given amount of time since the last RSSI signal reduction; after certain user behavior, such as opening a wallet, geofence entry, etc.; after a successful operation on the UE 110; after a reboot of UE 110 or a bio-lockout exit; and/or after a companion device to the UE 110 resets for any of the above reasons. As seen on the right side of FIG. 4, once the trigger condition is met, the scan sensitivity of the UE 110 is reset. In some example embodiments, the scan sensitivity may be reset to −106 dBm.

Specifically, as seen in FIG. 4, one condition that triggers a reset of the scan sensitivity may be a known door lock. For example, the UE 110 may have been near an unknown door lock or a door lock to which the user is not authorized to open for a period of time and the scan sensitivity has been reduced to BT bubble 420-4 (−70 dBm) due to unsuccessful attempts. Then the user associated with UE 110 goes to a different door lock that is known and to which the user is authorized to gain access. Once the UE 110 is close enough to the known door lock that a successful detection and connection may be made, the UE 110 may then be reset to using an unrestricted RSSI signal strength. In another example, if a user associated with UE 110 enters a certain geofence location (e.g., building or office area), the UE 110 may recognize that it is in a known area, and may be reset to using an unrestricted RSSI signal strength. In another example embodiment, a timer associated with the UE 110 may be set to a predefined time upon the reduction of the RSSI signal strength. Once the timer expires, the UE 110 may then be reset to using an unrestricted RSSI signal strength.

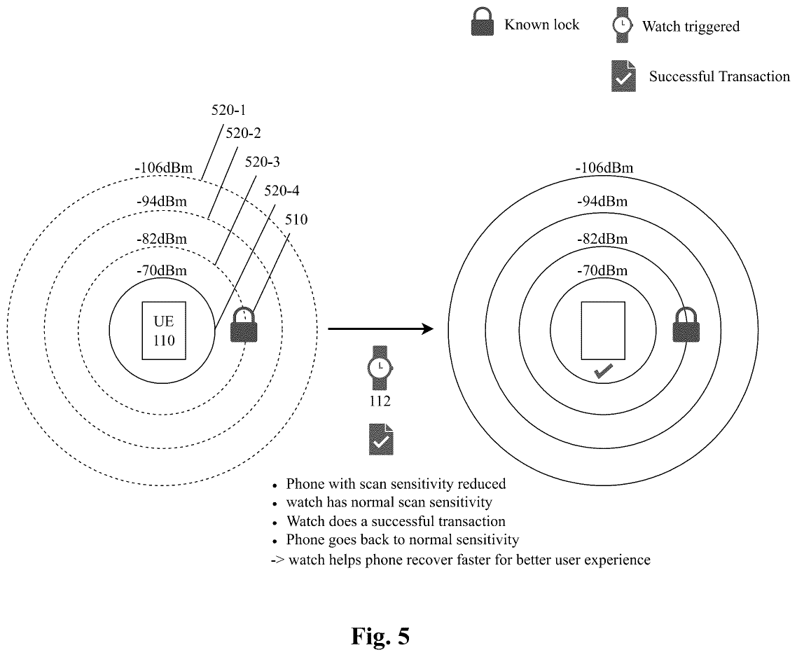

FIG. 5 shows a diagram illustrating how an example wireless device is reset to use a typical BT RSSI signal strength when certain conditions are met for a companion wireless device according to various example embodiments. For example, in FIG. 5, the UE 110 is a cellular phone and UE 112 is a companion watch. There may be a lock 510 near the UE 110 that is unknown to the user. The UE may have a plurality of different BT bubbles 520 associated with the UE 110, each BT bubble 520 having a different BT bubble signal strength (different RSSI signal strengths for triggering device discovery and connections with other devices). For example, BT bubble 520-1 may have a BT bubble signal strength of −106 dBm, BT bubble 520-2 may have a BT bubble signal strength of −94 dBm, BT bubble 520-3 may have a BT signal strength of −82 dBm, and BT bubble 520-4 may have a BT bubble signal strength of −70 dBm.

On the left side of FIG. 5, the scan sensitivity of an example wireless device may have been reduced due to a number of unsuccessful connection attempts, such as shown in FIG. 3. For example, as seen in FIG. 5, the RSSI signal strength that would trigger device discovery and connection attempts has been reduced to −70 dBm (BT bubble 520-4). At this point, the lock 510 may be outside the functional BT bubble 520-4. The UE 110 at this point may have been locked out totally from communicating with other devices or at least locked out from any reasonable connection to other devices.

To provide a balance between avoiding a power drain on a UE by using the mechanism described herein to reduce the scan sensitivity of the UE and still being able to have connectivity with other devices when desired, it may be beneficial to reset the UE to using a typical BT RSSI signal strength to discover and connect to other devices. In some example embodiments, as seen in FIG. 5, a reset occurs when a companion device meets a certain condition. In FIG. 5, the UE 110 (phone) is on a bubble and has had its scan sensitivity reduced (e.g., is using a restricted RSSI) due to previous unsuccessful connections. The UE 112 (watch) is a companion device to the UE 110 (e.g., may be a paired BT device to UE 110). When the UE 112 performs a successful transaction, the UE 110 (phone) may be reset (e.g., the phone may go back to a typical unrestricted RSSI to trigger device discovery and connections with other devices), as seen in the right side of FIG. 5.

In some example embodiments, the UE 110 (phone) may be locked out from being able to detect and connect to other devices due to a series of unsuccessful connections causing the RSSI to be heavily restricted. However, the companion watch (UE 112) may not be locked out from being able to detect and connect to other devices. This may be because the watch is newer, has more battery life or power, and/or is less sensitive to other devices. In this situation, the watch may be able to perform an action of some type (e.g., detected a valid device) and may notify the phone that it has detected a valid device and that the phone may rest itself to go back to using an unrestricted RSSI signal strength. In this manner, the watch (UE 112) helps the phone (UE 110) recover faster from being locked out, thereby improving user performance.

Alternatively, this reset due to a condition of a companion device also works in the other direction. For example, in some example embodiments, if UE 112 is a watch and the watch is in a mode where a restricted RSSI signal strength was being used to avoid power drain on the watch due to unnecessary connection attempts, the watch may be reset to a mode where an unrestricted RSSI signal strength is used when the companion phone (UE 110) performs a successful transaction.

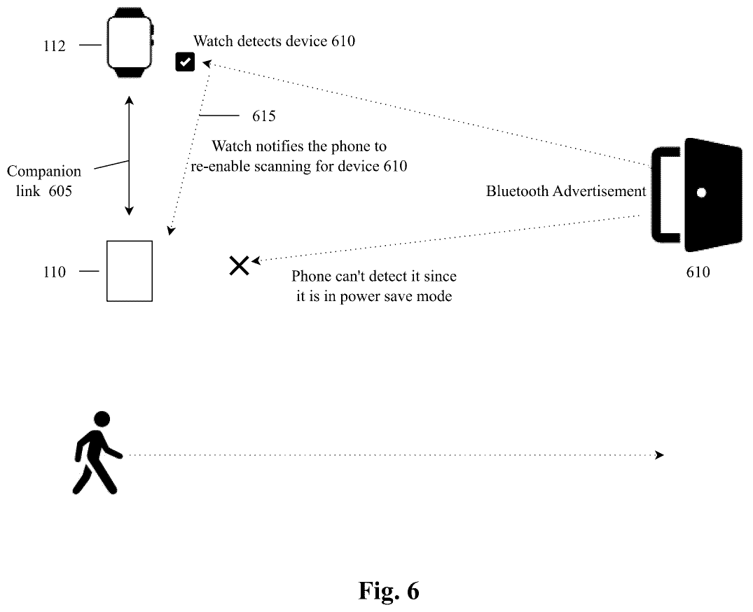

FIG. 6 shows a diagram illustrating how an example smart watch notifies an example BT-enabled cellular telephone that is in a power-saving mode to re-enable scanning for a third device according to various example embodiments. Referring to FIG. 6, a user associated with a UE 110 (such as a cellular phone) and a companion UE 112 (such as a smart watch) linked to UE 110 via companion link 605 may be approaching a third unconnected and unpaired device 610. In some example embodiments, device 610 may be a door lock. The UE 110 is in a power-saving mode and cannot detect the device 610. However, the UE 112 (smart watch) is not in a power-saving mode and detects the device 610. The UE 112 may then transmit a notification 615 to the UE 110 to re-enable scanning for the device 610. In some example embodiments, this may be accomplished by resetting the BT RSSI signal strength for discovering and connecting to devices for the UE 110 as discussed herein.

### EXAMPLES

In a first example, a method, comprising scanning for wireless devices using a first Received Signal Strength Indicator (RSSI) threshold for triggering a discovery of a wireless device, upon a determination that one or more erroneous scans have occurred, dynamically reducing a scan sensitivity of the apparatus by decreasing the first RSSI threshold to a second RSSI threshold for triggering the discovery of the wireless device, wherein the second RSSI threshold is to be used in additional scans and progressively continuing to reduce the scan sensitivity by continuing to decrease a RSSI threshold for triggering the discovery of the wireless device for subsequent scans until a non-erroneous scan occurs.

In a second example, the method of the first example, wherein each of the first RSSI threshold and second RSSI threshold for triggering a discovery of a wireless device is a Bluetooth (BT) RSSI for triggering a discovery of an unpaired BT wireless device.

In a third example, the method of the first example, wherein once the scan sensitivity has been reduced to a point where the RSSI threshold for triggering the discovery of the wireless device for subsequent scans has reached a threshold and a non-erroneous scan has not occurred, disabling scanning.

In a fourth example, the method of the first example, further comprising sending a notification to a user device associated with the user, the notification indicating that scanning has been disabled for the apparatus.

In a fifth example, the method of the first example, further comprising resetting to use the first RSSI threshold for scanning upon an occurrence of a reset condition.

In a sixth example, the method of the fifth example, wherein the reset condition is a passage of a predetermined amount of time since a most recent reduction of the RSSI threshold for triggering the discovery of the wireless device.

In a seventh example, the method of the fifth example, wherein the reset condition is a user behavior of a user.

In an eighth example, the method of the fifth example, wherein the reset condition is a successful scan and connection to the wireless device.

In a ninth example, the method of the fifth example, wherein the reset condition is a reboot or bio-lockout exit of an apparatus performing the method.

In a tenth example, the method of the fifth example, wherein the reset condition is a reset of a companion device, the reset of the companion device comprising one or more of: a passage of a predetermined amount of time since a most recent reduction of the RSSI for triggering the discovery of the wireless device; a user behavior of a user associated with the companion device; a successful scan and connection to the wireless device performed by the companion device; and a reboot or bio-lockout exit of the companion device.

In an eleventh example, the method of the tenth example, wherein an apparatus performing the method is a Bluetooth-enabled cellular telephone and the companion device is a smart watch.

In a twelfth example, the method of the first example, further comprising dynamically reducing the scan sensitivity by decreasing the first RSSI threshold a predetermined amount for each of three erroneous scans.

In a thirteenth example, the method of the twelfth example, wherein the predetermined amount is twelve (12) dB and the first RSSI is −106 dBm.

In a fourteenth example, the method of the first example, wherein an apparatus performing the method is an unpaired Bluetooth-enabled device.

In a fifteenth example, a processor configured to perform any of the methods of the first through fourteenth examples.

In a sixteenth example, a user equipment (UE) configured to perform any of the methods of the first through fourteenth examples.

In a seventeenth example, a method performed by an apparatus wirelessly linked to a companion device, wherein the companion device is in a power-saving mode in which scanning for wireless devices has been disabled, the method comprising scanning for wireless devices using a Received Signal Strength Indicator (RSSI) threshold, and upon successfully detecting a wireless device, transmitting a notification to the companion device to re-enable scanning for the wireless device by the companion device.

In an eighteenth example, the method of the seventeenth example, wherein the apparatus is a Bluetooth-enabled cellular telephone and the companion device is a smart watch.

In a nineteenth example, the method of the seventeenth example, wherein the apparatus is a smart watch and the companion device is a Bluetooth-enabled cellular telephone.

In a twentieth example, a processor configured to perform the method of the seventeenth example.

In a twenty first example, a user equipment (UE) configured to perform the method of the seventeenth example.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above-described method may be embodied as a program containing lines of code stored on a non-transitory computer readable storage medium that, when compiled, may be executed on a processor or microprocessor.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
scan for wireless devices using a first Received Signal Strength Indicator (RSSI) threshold for triggering a discovery of a wireless device;
upon a determination that one or more erroneous scans have occurred, dynamically reduce a scan sensitivity of the apparatus by decreasing the first RSSI threshold to a second RSSI threshold for triggering the discovery of the wireless device, wherein the second RSSI threshold is to be used in additional scans; and
progressively continue to reduce the scan sensitivity of the apparatus by continuing to decrease a RSSI threshold for triggering the discovery of the wireless device for subsequent scans until a non-erroneous scan occurs.

2. The apparatus of claim 1, wherein each of the first RSSI threshold and second RSSI threshold for triggering a discovery of a wireless device is a Bluetooth (BT) RSSI for triggering a discovery of an unpaired BT wireless device.

3. The apparatus of claim 1, wherein once the scan sensitivity of the apparatus has been reduced to a point where the RSSI threshold for triggering the discovery of the wireless device for subsequent scans has reached a threshold and a non-erroneous scan has not occurred, the processing circuitry is configured to disable scanning for the apparatus.

4. The apparatus of claim 1, wherein the processing circuitry is configured to send a notification to a user device associated with the user, the notification indicating that scanning has been disabled for the apparatus.

5. The apparatus of claim 1, wherein the processing circuitry is reset to use the first RSSI threshold for scanning upon an occurrence of a reset condition.

6. The apparatus of claim 5, wherein the reset condition is a passage of a predetermined amount of time since a most recent reduction of the RSSI threshold for triggering the discovery of the wireless device.

7. The apparatus of claim 5, wherein the reset condition is a user behavior of a user associated with the apparatus.

8. The apparatus of claim 5, wherein the reset condition is a successful scan and connection to the wireless device performed by the apparatus.

9. The apparatus of claim 5, wherein the reset condition is a reboot or bio-lockout exit of the apparatus.

10. The apparatus of claim 5, wherein the reset condition is a reset of a companion device of the apparatus, the reset of the companion device comprising one or more of: a passage of a predetermined amount of time since a most recent reduction of the RSSI for triggering the discovery of the wireless device; a user behavior of a user associated with the companion device; a successful scan and connection to the wireless device performed by the companion device; and a reboot or bio-lockout exit of the companion device.

11. The apparatus of claim 10, wherein the apparatus is a Bluetooth-enabled cellular telephone and the companion device is a smart watch.

12. The apparatus of claim 1, wherein the processing circuitry is configured to dynamically reduce the scan sensitivity of the apparatus by decreasing the first RSSI threshold a predetermined amount for each of three erroneous scans.

13. The apparatus of claim 12, wherein the predetermined amount is twelve (12) dB and the first RSSI is −106 dBm.

14. The apparatus of claim 1, wherein the apparatus is an unpaired Bluetooth-enabled device.

15. A method performed by an apparatus comprising:
scanning for wireless devices using a first Received Signal Strength Indicator (RSSI) threshold for triggering a discovery of a wireless device;
upon a determination that one or more erroneous scans have occurred, dynamically reducing a scan sensitivity of the apparatus by decreasing the first RSSI threshold to a second RSSI threshold for triggering the discovery of the wireless device, wherein the second RSSI threshold is to be used in additional scans; and
progressively continuing to reduce the scan sensitivity of the apparatus by continuing to decrease a RSSI threshold for triggering the discovery of the wireless device for subsequent scans until a non-erroneous scan occurs.

16. The method of claim 15, wherein once the scan sensitivity of the apparatus has been reduced to a point where the RSSI threshold for triggering the discovery of the wireless device for subsequent scans has reached a threshold and a non-erroneous scan has not occurred, the method further comprising disabling scanning for the apparatus.

17. The method of claim 15, further comprising resetting the apparatus to use the first RSSI threshold for scanning upon an occurrence of a reset condition, wherein the reset condition is one or more of: a passage of a predetermined amount of time since a most recent reduction of the RSSI threshold for triggering the discovery of the wireless device; a user behavior of a user associated with the apparatus or a companion device to the apparatus; a successful scan and connection to the wireless device performed by the apparatus or a companion device to the apparatus; and a reboot or bio-lockout exit of the apparatus or a companion device to the apparatus.

18. An apparatus wirelessly linked to a companion device, wherein the companion device is in a power-saving mode in which scanning for wireless devices has been disabled, the apparatus comprising processing circuitry configured to:
scan for wireless devices using a Received Signal Strength Indicator (RSSI) threshold; and
upon successfully detecting a wireless device, transmitting a notification to the companion device to re-enable scanning for the wireless device by the companion device.

19. The apparatus of claim 18, wherein the apparatus is a Bluetooth-enabled cellular telephone and the companion device is a smart watch.

20. The apparatus of claim 18, wherein the apparatus is a smart watch and the companion device is a Bluetooth-enabled cellular telephone.
